(19) United States
(12) Patent Application Publication
(10) Pub. No.: US 2017/0041941 A1
(43) Pub. Date: Feb. 9, 2017

(54) EFFICIENT CONTENTION BASED DECENTRALIZED PROCEDURE FOR DEVICE TO DEVICE COMMUNICATION

(71) Applicant: SONY CORPORATION, Tokyo (JP)

(72) Inventors: Feng Chen, Beijing (CN); Yong Zhao, Beijing (CN); Dahai Liu, Beijing (CN); Na Wei, Beijing (CN)

(21) Appl. No.: 14/352,746

(22) PCT Filed: Mar. 21, 2014
(86) PCT No.: PCT/CN2014/073816

§ 371 Date: Apr. 18, 2014

(51) Int. Cl. H04W 72/12; H04W 72/02; H04L 12/26; H04L 5/00; H04W 40/00

(52) U.S. Cl. CPC H04W 72/1215; H04L 5/0055; H04W 40/005; H04L 43/16; H04W 72/02; H04W 88/06

(57) ABSTRACT

Embodiments are directed to systems, methods and computer program products for enhancing contention-based device to device (D2D) resource allocation, where resources are allocated on a non-user device specific basis. Embodiments include initiating communication, by a first user device, a resource request message (RR) to a second user device; receiving, by the first user device from the second user device and in response to the resource request message, an acknowledge to transmit message (AT); and in response to receiving the AT, initiating a first data communication session, by the first user device, between the first user device and the second user device.

### BACKGROUND

The Third Generation Partnership Project (3GPP) radio access network (RAN) collaboration has addressed device to device (D2D) communication through proximity services (ProSe) or proximity based applications. A core component of proximity services is discovery of user equipment (UE), also referred to as user devices, apparatuses and the like. ProSe communication may involve two or more UEs in proximity to one another. Identified use cases for proximity-based services include public safety and non-public safety scenarios.

Discovery signal and communication resource allocation for D2D is currently under discussion. The two resource allocations under discussion are “contention-based” type 1 and “non-contention-based” type 2 methods. Detailed signaling and procedures for these allocation methods have not been finalized. Accordingly, solutions for contention-based type 1 resource allocation are needed for D2D communication.

### BRIEF SUMMARY

Embodiments of the invention are directed to systems, methods and computer program products for enhancing contention-based device to device (D2D) resource allocation, where resources are allocated on a non-user device specific basis. According to embodiments of the invention, a method includes initiating communication, by a first user device, a resource request message (RR) to a second user device; receiving, by the first user device from the second user device and in response to the resource request message, an acknowledge to transmit message (AT); and, in response to receiving the AT, initiating a first data communication session, by the first user device, between the first user device and the second user device.

In some embodiments, the first user device does not have a dedicated resource for D2D communication. In some such embodiments, the first user device is located in an in-coverage region and an eNB or group head for the in-coverage region is not configured to manage some or all D2D resources. In other such embodiments, the first user device is located in a decentralized region wherein no eNB or group head exists to manage D2D resource allocation. In some such embodiments, the RR comprises a sender/receiver ID, data size information, pointer of a resource block (RB), duration of communication information, and service type information; the AT comprises a sender/receiver ID, data size information, pointer of an RB, duration of communication information, and service type information; and RR and AT resource block locations are associated with predetermined fixed time or frequency offsets.

In some embodiments, the method also includes determining a packet size; comparing the determined packet size with a predetermined threshold; when packet size is greater than the predetermined threshold, determining that RR/AT transmission should be used; when packet size is less than the predetermined threshold, determining that non-RR/AT transmission should be used; and initiating a second data communication session, by the first user device with a third user device, based on the comparison; and initiating a second data communication session, by the first user device with a third user device, based on the comparison.

In some embodiments, the method includes dividing and dedicating a total number of available D2D resources into a RR/AT portion and a non-RR/AT portion; monitoring, by the first user device, the RR/AT portion of the resources and the non-RR/AT portion of the resources to determine; and in response to detecting a communication on the RR/AT portion of the resources or the non-RR/AT portion of the resources, performing, by the first user device, one or more corresponding actions or entering one or more corresponding modes.

In some embodiments, the method also includes receiving, by the second user device, a second RR message sent by a third user device; determining, by the second user device, whether the second RR message and the RR message received from the first user device are in conflict; and in response to determining the RR message and the second RR message are not in conflict, initiating communication of a second AT message to the third user device.

In some embodiments, the method also includes initiating communication, by the first user device, a second resource request message (RR) to a third user device, wherein the second RR message is not in conflict with the RR message; receiving, by the first user device from the third user device and in response to the second RR message, a second AT message; and in response to receiving the second AT message, initiating a second data communication session, by the first user device, between the first user device and the third user device.

In some embodiments, the method also includes selecting, by the first user device, at least one of a plurality of resources comprising a timing offset, frequency offset, resource block (RB) and/or carrier for communication of the RR message; and wherein initiating communication of the RR message comprises initiating communication based at least in part on the selected at least one resource. In some such embodiments, the method also includes monitoring, by the second user device, all resources across time, frequency and/or carriers to determine whether any RR or AT is present. In other such embodiments, selecting the at least one resource comprises randomly selecting at least one unused resource from the plurality of resources; and the RR message has a resource location and the AT message has a resource location that is a predetermined offset from the RR message resource location.

In some embodiments, the method includes randomly selecting, by the first user device, at least one of a plurality of resources comprising a timing offset, frequency offset, resource block (RB) and/or carrier for initiating a non-RR/AT data communication session, wherein the data to be transmitted has a size less than a predetermined packet size limit and the selected resource has a data size greater than or equal to the size of the data to be transmitted; and initiating a non-RR/AT data communication session based at least in part on the randomly selected at least one resource.

In some embodiments, the method includes selecting, by the first user device, at least one of a plurality of resources comprising a timing offset, frequency offset, resource block (RB) and/or carrier for communication of the RR message, wherein selecting is based at least in part on one or more alignment parameters for aligning resource contention among multiple user devices; and initiating communication of the RR message comprises initiating communication based at least in part on the selected at least one resource.

In some embodiments, the method includes selecting, by the first user device, at least one of a plurality of resources comprising a timing offset, frequency offset, resource block (RB) and/or carrier for initiating a non-RR/AT data communication session, wherein selecting is based at least in part on one or more alignment parameters for aligning resource contention among multiple user devices; and initiating a non-RR/AT data communication session based at least in part on the selected at least one resource. In some such embodiments, the alignment parameters dictate that non-RR/AT data communication sessions should be placed with a resource unallocated by any RR/AT communication. In other such embodiments, the alignment parameters dictate that non-RR/AT data communication sessions should be placed with a predetermined time, frequency and/or carrier slot of a resource.

In some embodiments, the alignment parameters dictate that RR/AT messages and RR/AT data communication sessions should be placed with a first and second predetermined time, frequency and/or carrier slot, respectively, of a resource.

In some embodiments, the method also includes monitoring, by the first user device, all resources allocated for AT messages, based at least in part on the alignment parameters; and determining, by the first user device, the RR/AT data communication session should be placed with a next available time, frequency and/or carrier slot of a resource based at least in part on a plurality of indexed RR/AT resources. In some embodiments, the RR and AT messages are communicated over a first shared resource having a first location, and the method further comprises determining a second location of a second shared resource based on the first location and based on at least one predetermined linking parameter, wherein the second shared resource has a second resource block size and the first data communication session is placed on the second shared resource at the second location; initiating a second data communication session placed on a third shared resource at a third location having a third resource block size; wherein the third resource block size is different than the second resource block size.

In some embodiments, the RR and AT messages indicate a traffic type associated with the communication data session, and the method further comprises determining a resource allocation based at least in part on the traffic type.

In some embodiments, the second user device is a group head for a plurality of group user devices, and the method further comprises forwarding the first data communication session, by the second communication device to the plurality of group user devices.

According to embodiments of the invention, an apparatus includes a memory; a processor; and a module stored in the memory, executable by the processor, and configured to initiate communication a resource request message (RR) to a second apparatus; receive, from the second apparatus and in response to the resource request message, an acknowledge to transmit message (AT); and in response to receiving the AT, initiate a first data communication session between the apparatus and the second apparatus.

According to embodiments of the invention, a computer program product includes a non-transitory computer-readable medium comprising a set of codes for causing a computer to initiate communication a resource request message (RR) to a second apparatus; receive, from the second apparatus and in response to the resource request message, an acknowledge to transmit message (AT); and in response to receiving the AT, initiate a first data communication session between the apparatus and the second apparatus.

### BRIEF DESCRIPTION OF THE DRAWINGS

Having thus described embodiments of the invention in general terms, reference will now be made to the accompanying drawings, where:

FIG. 1 illustrates various network coverage scenarios for two user equipment devices;

FIG. 2 illustrates an environment wherein user equipment devices and network systems operate according to embodiments of the invention;

FIG. 3 is a flowchart illustrating a method for enhancing contention-based device to device (D2D) resource allocation, where resources are allocated on a non-user device specific basis, according to embodiments of the invention;

FIG. 4 illustrates a diagram of an RR/AT decentralized procedure according to embodiments of the invention;

FIG. 5 illustrates a diagram of dedicated resource blocks mapping for decentralized procedure according to embodiments of the invention;

FIG. 6 illustrates a diagram showing a procedure for a UE to respond to multiple RR messages according to embodiments of the invention;

FIG. 7 illustrates a diagram of general resource blocks mapping for decentralized procedure according to embodiments of the invention;

FIG. 8A illustrates an RR/AT timing alignment map according to embodiments of the invention;

FIG. 8B illustrates an index of previous RR/AT resources according to embodiments of the invention;

FIG. 9 illustrates a diagram of different types of RR/AT messages linked to different type/size resource blocks according to embodiments of the invention; and

FIG. 10 illustrates a diagram showing a procedure for RR/AT in D2D broadcasting according to embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some potential implementations, the network, such as network eNB 120 will assign or allocate common resources for all D2D users for use in discovery and communication data sessions. Such allocation may provide resource and signaling efficiency.

There are two types of communications. “Type 1” refers to a contention-based communication procedure where resources for data transmission are allocated on a non-UE-specific basis. For type 1 communications, resources can be for all UEs or group of UEs. “Type 2” refers to a non-contention-based communication procedure where resources for data transmission are allocated on a per-UE specific basis. “Type 2A” is a subset of type 2 where resources are allocated for each specific transmission instance of data, and “type 2B” is a subset of type 2 where resources are semi-persistently allocated for data transmission.

Type 1 communication is typically considered baseline, especially for decentralized communication procedure, that is, where no group head or eNB is available to manage resource allocation for data transmission. During transmission, data collisions may happen randomly and result in failure of transmission.

An example collision scenario may involve a sending UE A wants to send data to receiving UE C, but UE A is unaware that UE B is already transmitting data to UE C. When UE A initiates data communication with UE C, a collision of the data transmissions may occur, and eventually UE C cannot decode data from UE A and UE B. Thus, when UEs need to transmit large amounts of data, the possibility of collision with other data transmissions increases and network efficiency is drastically reduced.

Another example problem involves power consumption by over monitoring a resource. In order to reduce collisions, UEs may need to check availability of resources before sending data. Thus, a UE may have to continuously monitor a resource. Such monitoring results in unnecessary power consumption.

Accordingly, embodiments of the invention are directed to system, methods and computer program products for enhancing contention-based device to device (D2D) resource allocation, where resources are allocated on a non-user device specific basis. For contention-based resource allocation (type 1) for D2D communication, embodiments of the invention are directed to a contention mechanism having a ResourceRequest/AcktoTransmit (RR/AT) configuration to reduce the transmission collisions that may occur during large data transmission sessions. A sending UE sends the ResourceRequest (RR) message and receives the AcktoTransmit (AT) message from a receiving UE. The RR/AT discovery configuration dictates some or all of the resource allocation for subsequent data session transmission. The embodiments discussed herein, therefore, reduce the collision in a decentralized procedure, especially those collisions caused by large data transmission sessions, and provide power saving advantages due to the dedicated resources and/or timing for RR/AT discovery messaging and/or RR/AT data sessions because the UE need not monitor all resources.

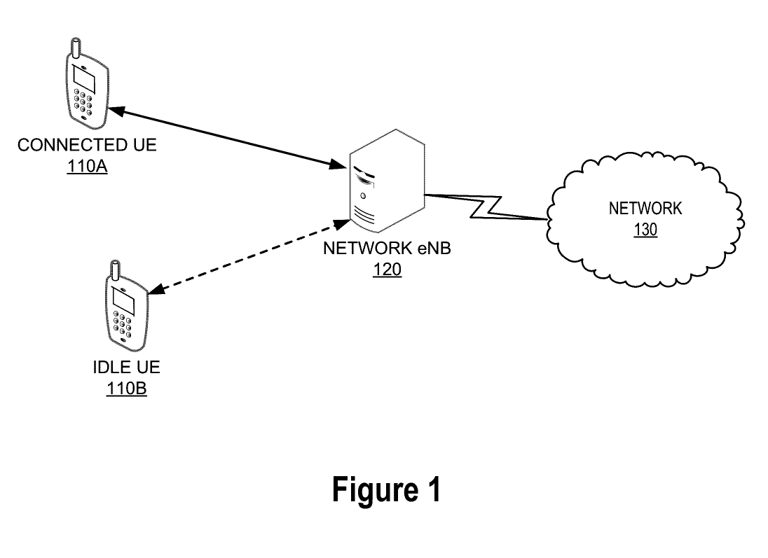

Referring now to FIG. 1, a network environment 100 is illustrated in accordance with one embodiment of the present invention. As illustrated in FIG. 1, some UEs may be connected to the network, such as connected UE 110A, whereas some UEs may be idle with the network or outside network coverage, such as idle UE 110B. As shown by the solid line, connected UE 110A is connected with the network 120 through network eNB 120. As shown by the dotted line, idle UE 110B is idle or disconnection from the network 120.

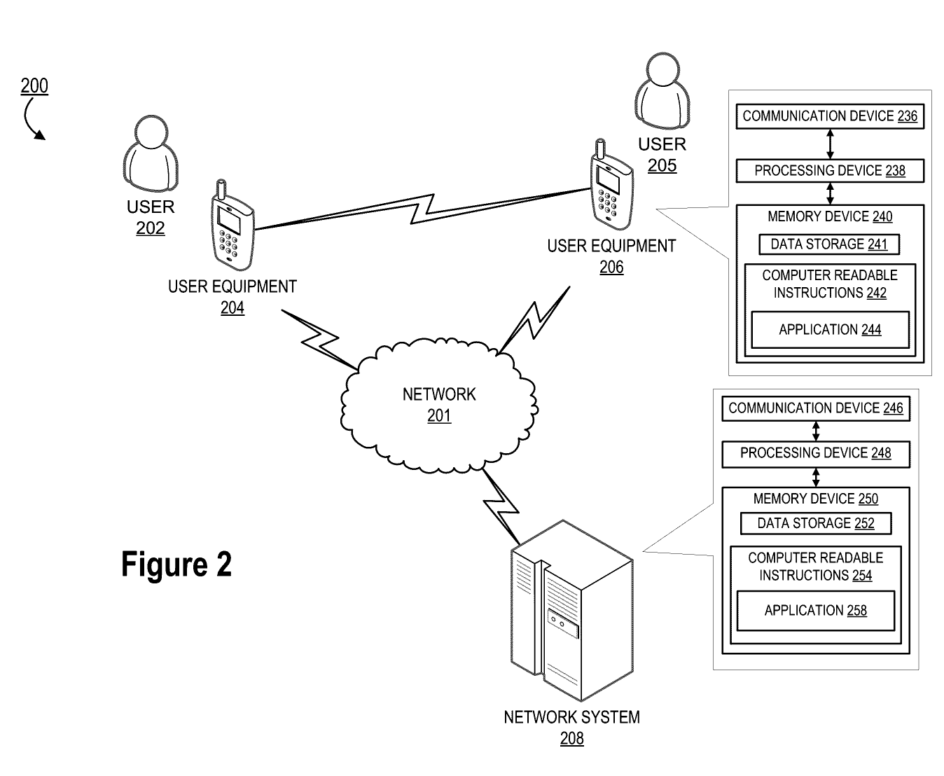

Referring now to FIG. 2, a network environment 200 is illustrated in accordance with one embodiment of the present invention. As illustrated in FIG. 2, the network system 208 is operatively coupled, via a network 201 to the user equipment 204 and/or 206. In this configuration, the network system 208 may send information to and receive information from the user equipment devices 204 and/or 206. FIG. 2 illustrates only one example of an embodiment of a network environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), a telecommunication network or any other type of network or combination of networks. The network 201 may provide for wireline, wireless, or a combination wireline and wireless communication between devices on the network 201.

In some embodiments, the users 202 and 205 are individuals who maintain cellular products with one or more providers.

As illustrated in FIG. 2, the network system 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201. As such, the communication device 246 generally comprises a modem, server, or other device for communicating with other devices on the network 201.

As further illustrated in FIG. 2, the network system 208 comprises computer-readable instructions 254 stored in the memory device 250, which in one embodiment includes the computer-readable instructions 254 of an application 258. In some embodiments, the memory device 250 includes data storage 252 for storing data related to and/or used by the application 258.

In some embodiments, the application 258 may allow for communications between the UEs 204 and 206 with or without assistance from the network 201.

As illustrated in FIG. 2, the user equipment 206 generally comprises a communication device 236, a processing device 238, and a memory device 240. The processing device 238 is operatively coupled to the communication device 236 and the memory device 240. In some embodiments, the processing device 238 may send or receive data from the user equipment 204, and/or the network system 208 via the communication device 236 over a network 201. As such, the communication device 236 generally comprises a modem, server, or other device for communicating with other devices on the network 201.

As further illustrated in FIG. 2, the user equipment 206 comprises computer-readable instructions 242 stored in the memory device 240, which in one embodiment includes the computer-readable instructions 242 of an application 244. In the embodiment illustrated in FIG. 2, the application 244 allows the user equipment 206 to be linked to the network system 208 to communicate, via a network 201. The application 244 may also allow the user equipment 206 to connect directly (i.e., locally or device to device) with the user equipment 204 for proximity services (e.g., using either cellular based links or non-cellular based links).

It is understood that the servers, systems, and devices described herein illustrate one embodiment of the invention. It is further understood that one or more of the servers, systems, and devices can be combined in other embodiments and still function in the same or similar way as the embodiments described herein.

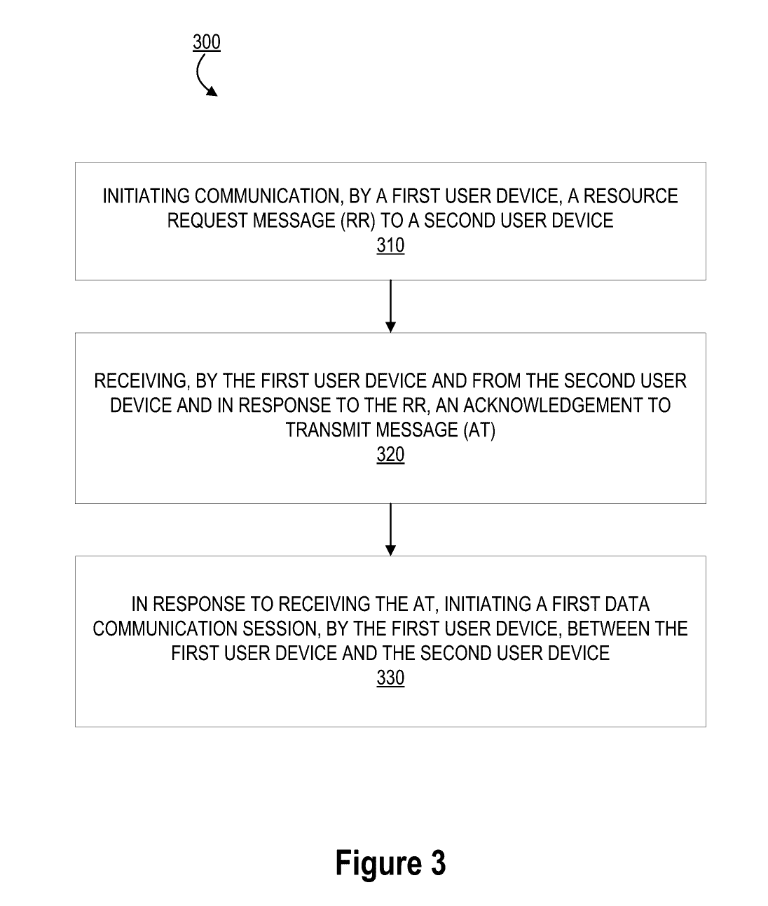

Referring now to FIG. 3, a flowchart illustrates a method 300 for enhancing contention-based device to device (D2D) resource allocation, wherein resources are allocated on a non-user device specific basis. The method includes initiating communication, by a first user device, a resource request message (RR) to a second user device as represented by block 310. The next step, as represented by block 320, is receiving, by the first user device from the second user device and in response to the resource request message, an acknowledge to transmit message (AT). Finally, as represented by block 330, in response to receiving the AT, initiating a first data communication session, by the first user device, between the first user device and the second user device.

Various embodiments of the invention rely on some assumptions. For example, in some embodiments, the first user device does not have a dedicated resource for D2D communication. Also, in some embodiments, the first user device is located in an in-coverage region and an eNB or group head for the in-coverage region is not configured to manage some or all D2D resources. Similarly, in some embodiments, the first user device is located in a decentralized region wherein no eNB or group head exists to manage D2D resource allocation.

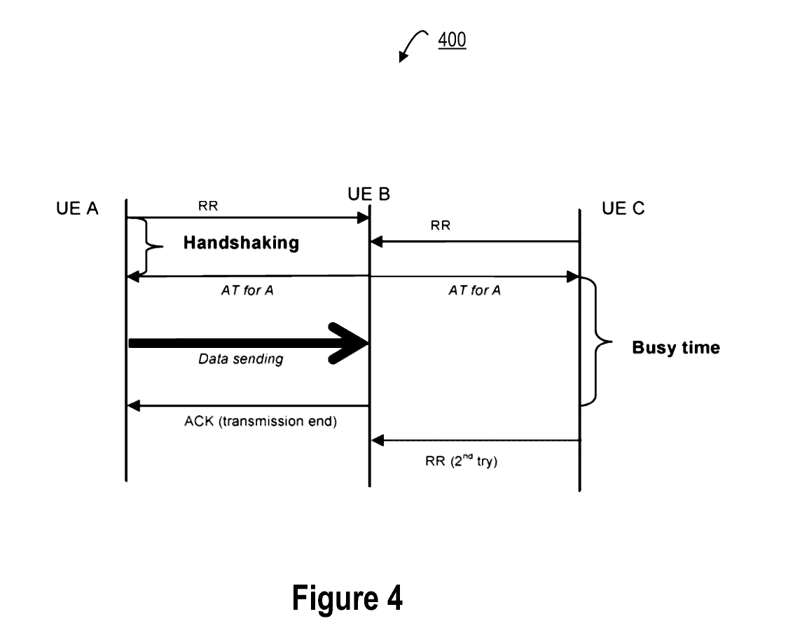

Referring now to FIG. 4, a diagram illustrates an RR/AT decentralized procedure according to embodiments of the invention. In some embodiments, the RR comprises a sender/receiver ID, data size information, pointer of a resource block (RB), duration of communication information, and service type information. Also, in some cases, the AT comprises a sender/receiver ID, data size information, pointer of an RB, duration of communication information, and service type information. Finally, in some cases, RR and AT resource locations are associated with predetermined fixed time or frequency offsets.

The example of FIG. 4 provides that UE A wants to communicate data with UE B. First, sending UE A sends an RR message to receiving UE B and other hidden UEs in the region. This RR message notifies other UEs that the sending UE is requesting to use some resource blocks (RBs) to communicate with the receiving UE. The receiving UE B receives the RR message from the sender and agrees to receive the data by transmitting an AT message to the sending UE A and other hidden UE. This is to notify them that the receiving UE accepts the request to use some resource blocks to communicate with the sender. The sender UE then sends data to the receiving UE using the RBs and at the time specified in the RR/AT messaging. The receiving UE B sends and ACK message to notify that data transmission is completed. The hidden UEs in the region get the RR or AT or both, and they then understand what RBs are occupied. These other UEs will not use the occupied resource blocks during the duration the data communication.

In various embodiments, the packet size of RR/AT transmissions may be limited by a threshold (e.g., 2 kilobytes). In other words, RR/AT transmissions should be used only for large data transmission in these embodiments. For small data transmissions, the RR/AT method may consume too much overhead, so that the network efficiency decreases. Accordingly, the packet (or data) size of the transmission is compared to a threshold to determine whether RR/AT or non-RR/AT transmissions should be used. If the data size to be transmitted is larger than the threshold (or packet size limit), RR/AT transmission is used, but if the data size to be transmitted is smaller than the threshold (or packet size limit), non-RR/AT transmissions are used.

The packet size limit can be set by an eNB, a group head or may be predetermined and/or preconfigured. In some embodiments, the process includes determining a packet size of the data to be transmitted and then comparing the packet size to a predetermined threshold, wherein the packet size limit (i.e., predetermined threshold) is determined by an eNB or group head. Then, the process includes initiating a second data communication session, by the first user device with a third user device based on the comparison.

For UEs within coverage, the packet size limit of the RT/AT transmission may be set by the eNB or group head. For UEs outside coverage, the packet size limit may be set to the latest size limit set by the eNB or group head. In some cases, the packet size limit for RR/AT transmissions may be preconfigured for the scenario where an eNB and/or a group head has not yet set any value for the packet size limit.

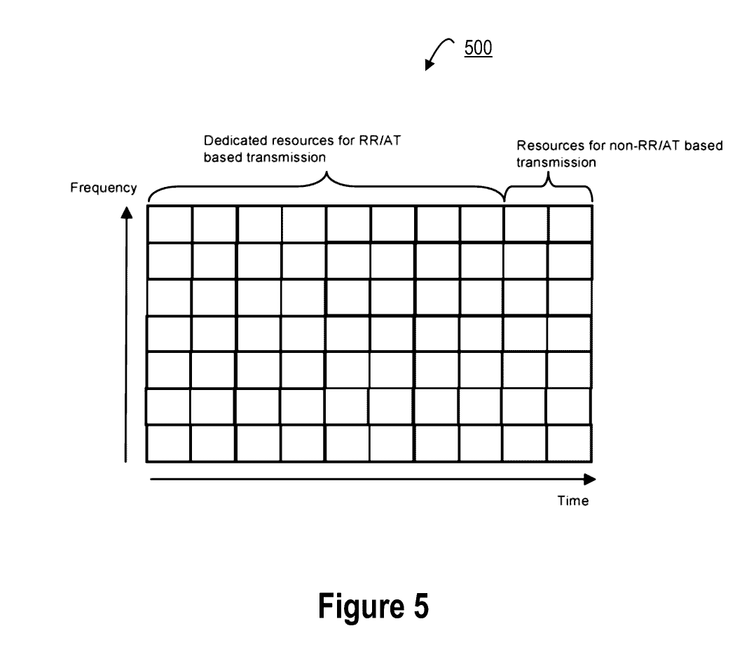

Referring now to FIG. 5, a diagram illustrates a dedicated resource blocks mapping for decentralized procedure according to embodiments of the invention. In some embodiments, non-RR/AT transmissions are supported. Reservation-based and non-reservation-based resources may be separated such that a portion of the D2D resources are dedicated for RR/AT based transmissions and another portion of resources are allocated for non-RR/AT transmissions. In some embodiments, the procedure includes dividing and dedicating a total number of available D2D resources into a RR/AT portion and a non-RR/AT portion, monitoring, by the first user device, the RR/AT portion of the resources and the non-RR/AT portion of the resources to determine and in response to detecting a communication on the RR/AT portion of the resources or the non-RR/AT portion of the resources, performing, by the first user device, one or more corresponding actions or entering one or more corresponding modes. The actions or modes may be different behaviors or modes that are supported simultaneously and they may be enabled by an eNB or group head or may be preconfigured.

The UE may have different modes to monitor the RBs. As mentioned above, these modes can be enabled by an eNB, a group head or preconfigured. For example, the UE typically claims which mode is being supported in the discovery signal with three data bits. In a first exemplary mode, the UE that enables the RR/AT transmission monitors dedicated RR/AT resources. In this first mode, the sender and receiver communicate in the linked resource, and the hidden UE (i.e., not performing a transmission) can shut down and save power. In a second exemplary mode, the UE that enables a non-RR/AT transmission monitors the resources for non-RR/AT transmissions.

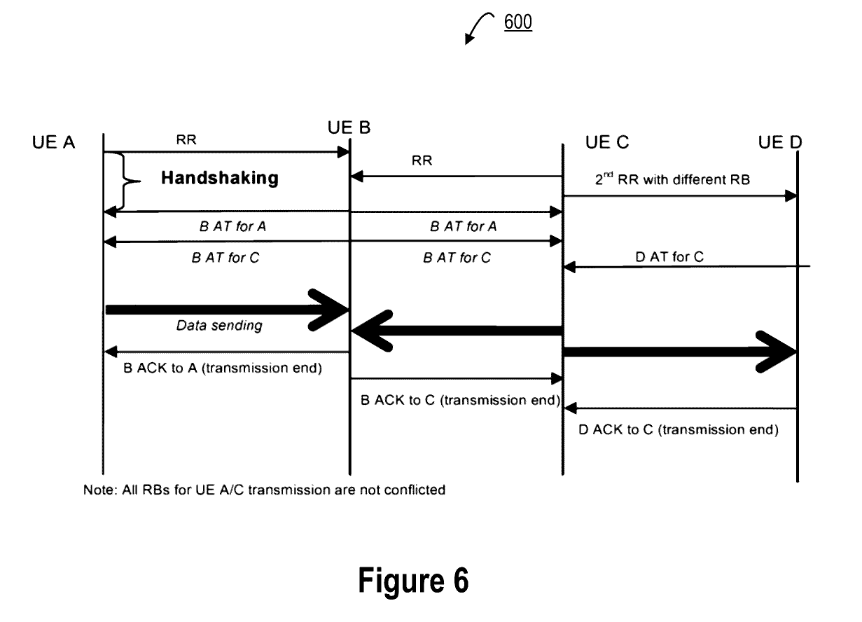

Referring now to FIG. 6, a diagram illustrates a procedure for a UE to respond to multiple RR messages according to embodiments of the invention. The UE may receive multiple requests from one or multiple UEs. The receiving UE should be able to accept these multiple requests if they are not conflicted with one another. The receiving UE could choose to accept the request based on the priority of a Sender ID, service type, duration or the like. The receiving UE could also have an algorithm to accept the requests, such as, to maximize the number of requests the receiving UE accepts.

Similarly, the sending UE may send multiple requests to one or multiple receiving UEs, either simultaneously or continuously. These requests should not conflict with one another, and the receiving UE will respond with an AT message separately. Based on the AT, the sending UE will transmit data accordingly.

Thus, embodiments of the process may include receiving, by the second user device, a second RR message sent by a third user device, determining, by the second user device, whether the second RR message and the RR message received from the first user device are in conflict, and in response to determining the RR message and the second RR message are not in conflict, initiating communication of a second AT message to the third user device. The process may also include initiating communication, by the first user device, a second resource request message (RR) to a third user device, wherein the second RR message is not in conflict with the RR message, receiving, by the first user device from the third user device and in response to the second RR message, a second AT message; and in response to receiving the second AT message, initiating a second data communication session, by the first user device, between the first user device and the third user device.

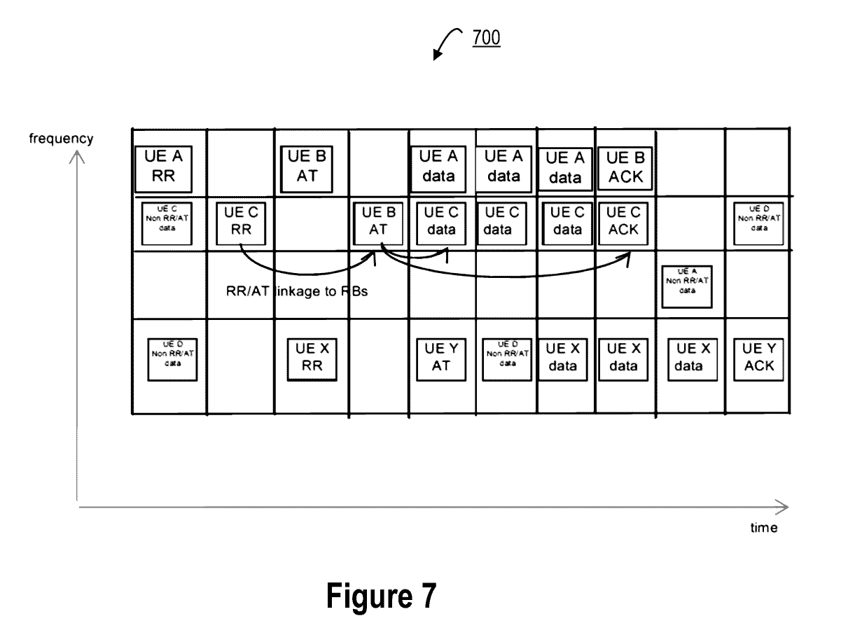

Referring now to FIG. 7, a diagram illustrates a general resource blocks mapping for decentralized procedure according to embodiments of the invention. An independent resource contention across frequency and/or carriers is provided such that the UE could send out the RR or AT at any timing or any RB/carrier. Because this configuration runs independently, the UE must monitor all the resources across frequency/carriers to check if there are any RR/AT messages. The sending UE may randomly select unused resources to send out RR, and the receiving UE responds with the AT in the paired resource, that is, the respective resource locations are linked by certain fixed time (or other types) of offsets. The RR/AT resource may be a fixed timing offset after a previous data session has ended. The sending UE may also randomly select unused resources to initiate non-RR/AT transmissions if the size of the data to be transmitted does not exceed a packet size limit.

Thus, in some embodiments, the process includes selecting, by the first user device, at least one of a plurality of resources comprising a timing offset, frequency offset, resource block (RB) and/or carrier for communication of the RR message; and initiating communication of the RR message comprises initiating communication based at least in part on the selected at least one resource. In some cases, the process also includes monitoring, by the second user device, all resources across time, frequency and/or carriers to determine whether any RR or AT is present, and in other cases, selecting the at least one resource comprises randomly selecting at least one unused resource from the plurality of resources, and the RR message has a resource location and the AT message has a resource location that is a predetermined offset from the RR message resource location. In some embodiments, the process includes randomly selecting, by the first user device, at least one of a plurality of resources comprising a timing offset, frequency offset, resource block (RB) and/or carrier for initiating a non-RR/AT data communication session, wherein the selected resource has a data size less than a predetermined packet size limit and initiating a non-RR/AT data communication session based at least in part on the randomly selected at least one resource.

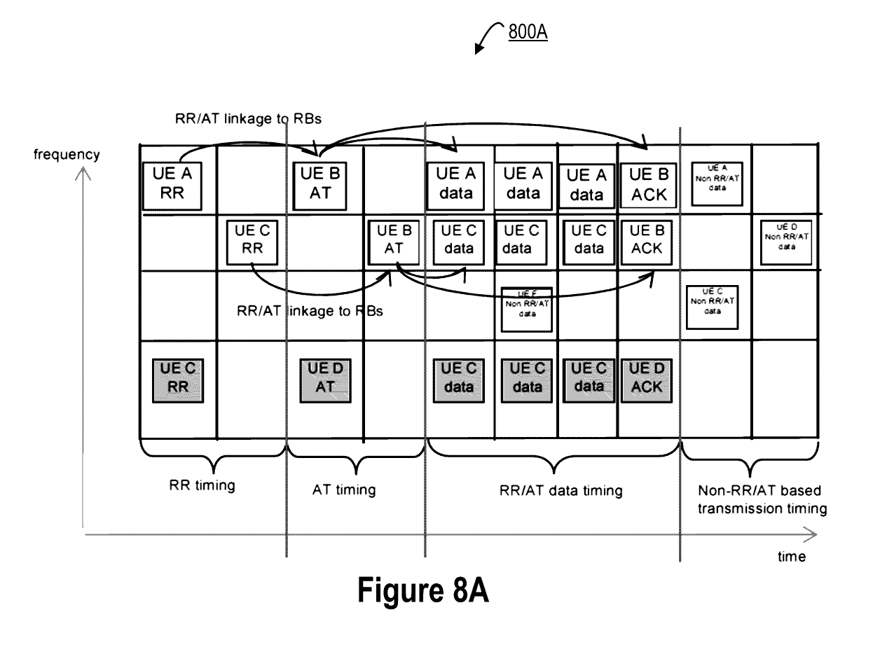

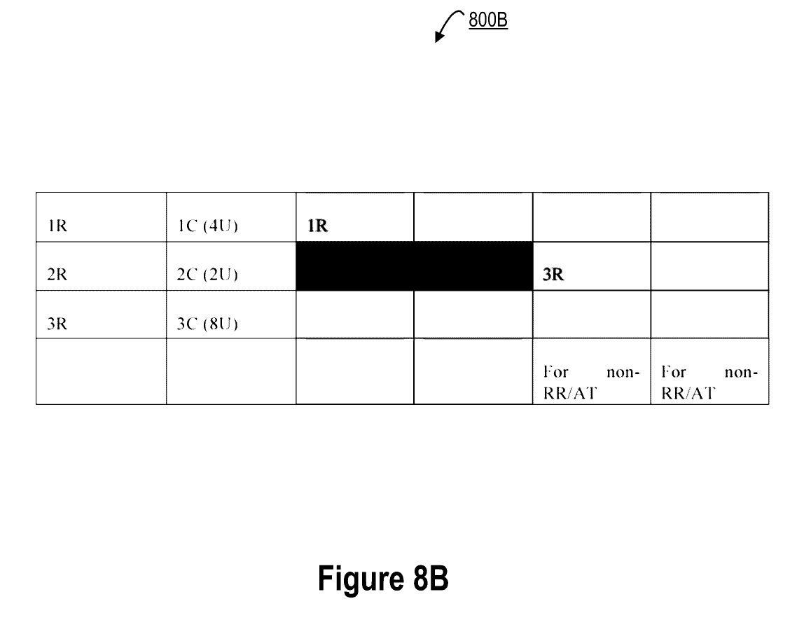

Referring now to FIG. 8A, an RR/AT timing alignment map is illustrated according to embodiments of the invention, and FIG. 8B illustrates an index of previous RR/AT resources according to embodiments of the invention. Dependent resource content across frequency and/or carriers provides that RR/AT timing across RBs/carriers can be aligned. In some cases, non-RR/AT transmissions can also be aligned or placed in unallocated resources.

The RR/AT across frequency/carrier could be time aligned to some specified known time slot. The timing of data transmissions may also be aligned. For example, all RR messages may be placed in [0, x), where x>0. Similarly, all AT messages may be placed in [x, 2x). Data transmission could be placed in [y, y+z), where y>2x and z>0.

In some embodiments as illustrated in FIG. 8B, for this dependent mode, all UE can monitor all ATs, and the exact resource location for data transmission is based on all previously indexed RR/AT resources.

The timing of non-RR/AT transmissions may be aligned within certain timeslots across frequencies/carriers as noted above. These may be placed at, for example, [y, y+x), where x>0 and y>0. In some scenarios, a non-RR/AT transmission may be made in the RBs unallocated by RR/AT transmission if they are not reserved in advance by any RR/AT.

In some embodiments, the UE may have different behaviors and/or modes upon monitoring RBs. For example, the UE may support one or multiple modes simultaneously. The mode can be enabled by an eNB or be preconfigured. The UE should claims which mode it is supporting in its discovery signal with three bits. Further, the UE may be configured to use frequency independent or dependent resource contention by its eNB and/or group head and/or it may be preconfigured.

In the example shown in the figures, the four frequency units/carriers' resource allocation are time-aligned. The reservation for resources can be made according to different UE's needs. The data resource for all is from up to down, and each transmission, the UE needs to decode all previous ATs to determine the start of its own data resource until the resource has been exhausted. For non-RR/AT transmissions, transmission may be allowed if there are leftover resources.

The UE may have different behaviors and/or modes upon monitoring RBs. The UE may support one or multiple modes simultaneously. The mode can be enabled by an eNB or be preconfigured. The UE should claim which mode it is supporting in its discovery signaling with three bits. In an exemplary first mode, the UE that enables the RR/AT transmission monitors the dedicated RR/AT timing. The sender and receiver then communicate in the paired resource. Any hidden UEs can then shut down and save power. In a second exemplary mode, the UE that enables the non-RR/AT timing transmission with timing aligned, can monitor the non-RR/AT timing In another exemplary mode, the UE that enables a non-RR/AT transmission without timing aligned monitors the resource blocks unallocated by the RR/AT transmission.

Thus, in some embodiments, the process includes selecting, by the first user device, at least one of a plurality of resources comprising a timing offset, frequency offset, resource block (RB) and/or carrier for communication of the RR message, wherein selecting is based at least in part on one or more alignment parameters for aligning resource contention among multiple user devices, and initiating communication of the RR message comprises initiating communication based at least in part on the selected at least one resource. In some cases, the process includes selecting, by the first user device, at least one of a plurality of resources comprising a timing offset, frequency offset, resource block (RB) and/or carrier for initiating a non-RR/AT data communication session, wherein selecting is based at least in part on one or more alignment parameters for aligning resource contention among multiple user devices; and initiating a non-RR/AT data communication session based at least in part on the selected at least one resource.

In some of these scenarios, the alignment parameters dictate that non-RR/AT data communication sessions should be placed with a resource unallocated by any RR/AT communication. In others of these scenarios, the alignment parameters dictate that non-RR/AT data communication sessions should be placed with a predetermined time, frequency and/or carrier slot of a resource.

In some scenarios, the alignment parameters dictate that RR/AT messages and RR/AT data communication sessions should be placed with a first and second predetermined time, frequency and/or carrier slot, respectively, of a resource. In other scenarios, the process includes monitoring, by the first user device, all resources allocated for AT messages, based at least in part on the alignment parameters; and determining, by the first user device, the RR/AT data communication session should be placed with a next available time, frequency and/or carrier slot of a resource based at least in part on a plurality of indexed RR/AT resources.

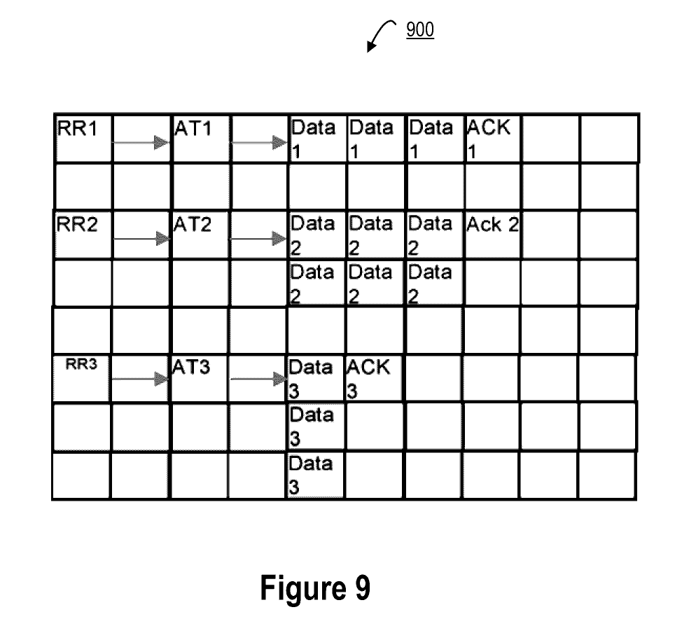

Referring now to FIG. 9, a diagram illustrates different types of RR/AT messages linked to different type/size resource blocks according to embodiments of the invention.

In some embodiments, different RR/AT resources can be linked to specified different RB size for data transmission. For example, a first RR/AT resource could be linked to the following three data units, while a second RR/AT resource could be linked to the following six data units.

Thus, in some embodiments of the process, the RR and AT messages are communicated over a first shared resource having a first location, and the process may include determining a second location of a second shared resource based on the first location and based on at least one predetermined linking parameter, wherein the first data communication session is placed on the second shared resource at the second location.

In some embodiments, different traffic types of the RR/AT resources can be linked to different kinds of resource allocation. For example, a different resource size may be used. The UEs may transmit different size data for different traffic types (e.g., 1RB for VoIP and 3RBs for data transfer). Therefore, in order to request appropriate resource size enhances the network efficiency. Because of service type, reserved RBs may have different offsets for frequency/time and the like. For example, one contention in VoIP RR/AT resource may be allowed to use certain periodical resources for certain times. In some embodiments, the sizes of resource blocks used for different data communication sessions are different.

Accordingly, the process may include RR and AT messages that indicate a traffic type associated with the communication data session, and the method may include determining a resource allocation based at least in part on the traffic type.

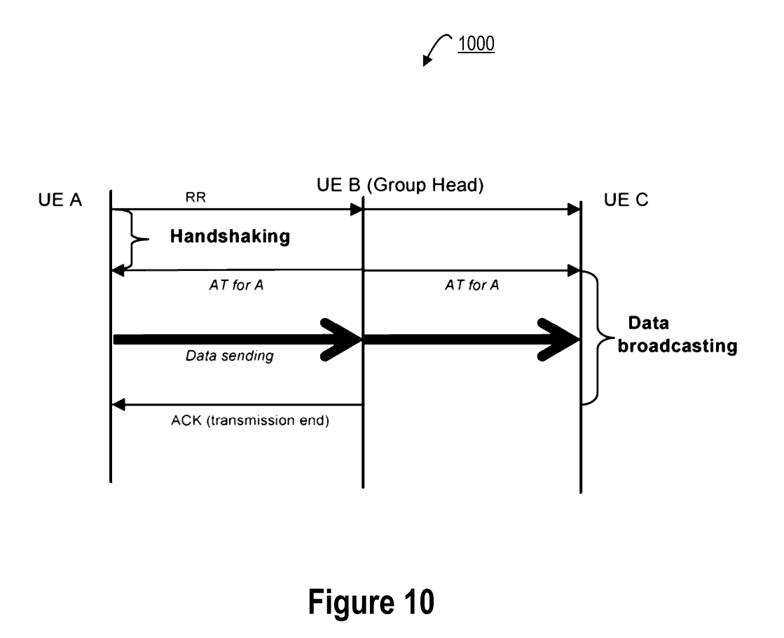

Referring now to FIG. 10, a diagram illustrates a procedure for RR/AT in D2D broadcasting according to embodiments of the invention. The mechanism of RR/AT can be applied to the scenario of D2D broadcasting (i.e., one to multiple data transmission). In some cases, the group head responds with an AT message to the sender's request.

Accordingly, the process may include the second user device being a group head for a plurality of group user devices, and forwarding the first data communication session, by the second communication device to the plurality of group user devices.

In some cases, the sending UE sends an RR to the group of users before transmitting data to the group users. The group head then decides to accept the request and responds. In some cases, the group head forwards the data transmission to the group and in some cases, the group head provides the individual group members' information using the AT such that the sending UE can communicate directly with each of the group UEs during the data transmission. In some cases, the group head broadcasts the data transmission to the group members.

It should be noted that the scenarios described above with reference to FIGS. 3-10 are meant only for illustration. Numerous applications of enhancing contention-based device to device (D2D) resource allocation, where resources are allocated on a non-user device specific basis, may be implemented.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for enhancing contention-based device to device (D2D) resource allocation, wherein resources are allocated on a non-user device specific basis, the method comprising:
initiating communication, by a first user device, a resource request message (RR) to a second user device;
receiving, by the first user device from the second user device and in response to the resource request message, an acknowledge to transmit message (AT); and
in response to receiving the AT, initiating a first data communication session, by the first user device, between the first user device and the second user device.

2. The method of claim 1,
wherein the first user device does not have a dedicated resource for D2D communication.

3. The method of claim 2,
wherein the first user device is located in an in-coverage region and an eNB or group head for the in-coverage region is not configured to manage some or all D2D resources.

4. The method of claim 2,
wherein the first user device is located in a decentralized region wherein no eNB or group head exists to manage D2D resource allocation.

5. The method of claim 4,
wherein the RR comprises a sender/receiver ID, data size information, pointer of a resource block (RB), duration of communication information, and service type information;
wherein the AT comprises a sender/receiver ID, data size information, pointer of an RB, duration of communication information, and service type information; and
wherein RR and AT resource block locations are associated with predetermined fixed time or frequency offsets.

6. The method of claim 1, further comprising:
determining a packet size;
comparing the determined packet size with a predetermined threshold;
when packet size is greater than the predetermined threshold, determining that RR/AT transmission should be used;
when packet size is less than the predetermined threshold, determining that non-RR/AT transmission should be used; and
initiating a second data communication session, by the first user device with a third user device, based on the comparison.

7. The method of claim 1, further comprising:
dividing and dedicating a total number of available D2D resources into a RR/AT portion and a non-RR/AT portion;
monitoring, by the first user device, the RR/AT portion of the resources and the non-RR/AT portion of the resources to determine; and
in response to detecting a communication on the RR/AT portion of the resources or the non-RR/AT portion of the resources, performing, by the first user device, one or more corresponding actions or entering one or more corresponding modes.

8. The method of claim 1, further comprising:
receiving, by the second user device, a second RR message sent by a third user device;
determining, by the second user device, whether the second RR message and the RR message received from the first user device are in conflict; and
in response to determining the RR message and the second RR message are not in conflict, initiating communication of a second AT message to the third user device.

9. The method of claim 1, further comprising:
initiating communication, by the first user device, a second resource request message (RR) to a third user device, wherein the second RR message is not in conflict with the RR message;
receiving, by the first user device from the third user device and in response to the second RR message, a second AT message; and
in response to receiving the second AT message, initiating a second data communication session, by the first user device, between the first user device and the third user device.

10. The method of claim 1, further comprising:
selecting, by the first user device, at least one of a plurality of resources comprising a timing offset, frequency offset, resource block (RB) and/or carrier for communication of the RR message; and
wherein initiating communication of the RR message comprises initiating communication based at least in part on the selected at least one resource.

11. The method of claim 10, further comprising:
monitoring, by the second user device, all resources across time, frequency and/or carriers to determine whether any RR or AT is present.

12. The method of claim 10,
wherein selecting the at least one resource comprises randomly selecting at least one unused resource from the plurality of resources; and
wherein the RR message has a resource location and the AT message has a resource location that is a predetermined offset from the RR message resource location.

13. The method of claim 1, further comprising:
randomly selecting, by the first user device, at least one of a plurality of resources comprising a timing offset, frequency offset, resource block (RB) and/or carrier for initiating a non-RR/AT data communication session, wherein the data to be transmitted has a size less than a predetermined packet size limit and the selected resource has a data size greater than or equal to the size of the data to be transmitted; and
initiating a non-RR/AT data communication session based at least in part on the randomly selected at least one resource.

14. The method of claim 1, further comprising:
selecting, by the first user device, at least one of a plurality of resources comprising a timing offset, frequency offset, resource block (RB) and/or carrier for communication of the RR message, wherein selecting is based at least in part on one or more alignment parameters for aligning resource contention among multiple user devices; and
wherein initiating communication of the RR message comprises initiating communication based at least in part on the selected at least one resource.

15. The method of claim 1, further comprising:
selecting, by the first user device, at least one of a plurality of resources comprising a timing offset, frequency offset, resource block (RB) and/or carrier for initiating a non-RR/AT data communication session, wherein selecting is based at least in part on one or more alignment parameters for aligning resource contention among multiple user devices; and
initiating a non-RR/AT data communication session based at least in part on the selected at least one resource.

16. The method of claim 15, wherein the alignment parameters dictate that non-RR/AT data communication sessions should be placed with a resource unallocated by any RR/AT communication.

17. The method of claim 15, wherein the alignment parameters dictate that non-RR/AT data communication sessions should be placed with a predetermined time, frequency and/or carrier slot of a resource.

18. The method of claim 14, wherein the alignment parameters dictate that RR/AT messages and RR/AT data communication sessions should be placed with a first and second predetermined time, frequency and/or carrier slot, respectively, of a resource.

19. The method of claim 14, further comprising:
monitoring, by the first user device, all resources allocated for AT messages, based at least in part on the alignment parameters; and
determining, by the first user device, the RR/AT data communication session should be placed with a next available time, frequency and/or carrier slot of a resource based at least in part on a plurality of indexed RR/AT resources.

20. The method of claim 1,
wherein the RR and AT messages are communicated over a first shared resource having a first location, the method further comprising:
determining a second location of a second shared resource based on the first location and based on at least one predetermined linking parameter, wherein the second shared resource has a second resource block size and the first data communication session is placed on the second shared resource at the second location;
initiating a second data communication session placed on a third shared resource at a third location having a third resource block size;
wherein the third resource block size is different than the second resource block size.

21. The method of claim 1,
wherein the RR and AT messages indicate a traffic type associated with the communication data session, the method further comprising:
determining a resource allocation based at least in part on the traffic type.

22. The method of claim 1,
wherein the second user device is a group head for a plurality of group user devices, the method further comprising:
forwarding and/or broadcasting the first data communication session, by the second communication device to the plurality of group user devices

23. An apparatus for enhancing contention-based device to device (D2D) resource allocation, wherein resources are allocated on a non-user device specific basis, the apparatus comprising:
a memory;
a processor; and
a module stored in the memory, executable by the processor, and configured to:
initiate communication a resource request message (RR) to a second apparatus;
receive, from the second apparatus and in response to the resource request message, an acknowledge to transmit message (AT); and
in response to receiving the AT, initiate a first data communication session between the apparatus and the second apparatus.

24. A computer program product for enhancing contention-based device to device (D2D) resource allocation, wherein resources are allocated on a non-user device specific basis, the computer program product comprising:
a non-transitory computer-readable medium comprising a set of codes for causing a computer to:
initiate communication a resource request message (RR) to a second apparatus;
receive, from the second apparatus and in response to the resource request message, an acknowledge to transmit message (AT); and
in response to receiving the AT, initiate a first data communication session between the apparatus and the second apparatus.
